(19) United States
(12) Patent Application Publication
(10) Pub. No.: US 2026/0037226 A1
(43) Pub. Date: Feb. 5, 2026

(54) ELECTRONIC DEVICE FOR RANDOM NUMBER GENERATION

(71) Applicant: Commissariat à l'Energie Atomique et aux Energies Alternatives, PARIS (FR)

(72) Inventors: Licinius-Pompiliu BENEA, GRENOBLE (FR); Florian PEBAY-PEYROULA, GRENOBLE (FR); Romain WACQUEZ, GRENOBLE (FR); Mikael CARMONA, GRENOBLE (FR)

(21) Appl. No.: 19/288,767

(22) Filed: Aug. 1, 2025

(30) Foreign Application Priority Data
Aug. 2, 2024 (FR) 2408601

(51) Int. Cl. G06F 7/58

(52) U.S. Cl. CPC G06F 7/588

(57) ABSTRACT

The present description concerns an electronic device (1) comprising: a first ring oscillator (RO1) and a second ring oscillator (RO2); a synchronous flip-flop (FF); a counter (COUNTER); a first circuit (Nm CTRL) configured to modify a period of at least one of the two oscillators (RO1, RO2) so that a mean difference between the periods of the two oscillators is equal to a target difference; and a second circuit (PROCESS) configured to: initialize a value of an integer K, calculate sums (VAL) of K successive values of the counter (COUNTER), calculate an Allan variance (VAR) on the calculated sums (VAL), and set K to its current value if the calculated variance is greater than a first threshold and increment K otherwise.

### FIELD

The present disclosure generally concerns electronic circuits, and more particularly entropy sources implemented in electronic circuits to generate random numbers.

### BACKGROUND

Many electronic circuits implement a true random number generation (TRNG) function. For this purpose, these circuits have an entropy source from which is extracted random information, or randomness. This random information also called, for example, measurand, is then used to generate random numbers. As an example, the random numbers thus obtained are used to generate encryption keys, signatures, etc.

Known entropy sources are based on the jitter of a ring oscillator. Ring oscillators are widely used due their simplicity and to the strong knowledge of their theoretical models. The uncertainty (or jitter) on the actual period of an output signal of a ring oscillator as compared with the theoretical period of this signal is used as a source of randomness. This uncertainty increases with the number of accumulated periods (or, equivalently, the accumulation time).

The physical phenomena behind jitter are well documented in literature. The model generally used as a theoretical basis is that provided by Hajimiri et al. in the article “Jitter and phase noise in ring oscillators” in IEEE J. Solid-State Circuits, vol. 34, no. 6, June 1999. This model defines the susceptibility function of the output signal of a ring oscillator to generate phase noise when facing a perturbation. More specifically, only a perturbation occurring during the transient (rise or fall) phases of the output signal is capable of inducing phase noise in this signal. Further, the model describes the effect of the different physical noise sources on the accumulated jitter. These phenomena include thermal noise resulting from thermal agitation and flicker noise induced by the charging/discharging of traps of the gate oxide, or, in other words, by the trapping/freeing of charges in the gate oxide of metal oxide semiconductor (MOS) transistors implementing the ring oscillator, or by carrier diffusion in the channel of these transistors. Indeed, the accumulated jitter comprises two regions: a region varying linearly with the variance of the jitter, which corresponds to thermal noise, and a region varying quadratically with the variance of the jitter, which corresponds to flicker noise.

To use jitter as a source of entropy for the generation of true random numbers, it is generally accepted that only the thermal component of jitter is of interest, since it is the only completely random component, and that the flicker noise component is not of interest, since flicker noise is self-correlated and detrimental to the predictability of the generated randomness.

Thus, in the above-described circuits where the entropy source for generating random numbers is based on the jitter of a ring oscillator, it is desirable to characterize the entropy source, that is, the jitter, to discriminate the amplitude of the thermal component of the jitter.

There exist embedded methods for characterizing, in a circuit, an entropy source based on the jitter of a first ring oscillator of the circuit by using a second oscillator of the circuit, which is identical to the first one. For example, the two oscillators are said to be identical to each other when they are identical by design.

A first method is disclosed in the article “On the assumption of mutual independence of jitter realizations in P-TRNG stochastic models”, by P. Haddad, Y. Teglia, F. Bernard, and V. Fischer, presented in “Design, Automation & Test in Europe Conference & Exhibition (DATE)”, in 2014, in Dresden. This first method consists in counting, with a counter, the number of oscillations of the first oscillator RO1 during Q oscillations of the second oscillator, factor Q being obtained via a frequency divider receiving the output signal of the second oscillator as an input signal. The counter is incremented by the output signal of the first oscillator and reset every Q periods of the output signal of the second oscillator, by means of the output signal of the divider of the frequency by Q. The jitter is then characterized by using the Allan variance calculated on the counter outputs. The Allan variance is the variance calculated on the difference between two consecutive values, here two consecutive output values of the counter, and enables to avoid problems related to model convergence while respecting a stationarity condition. The Allan variance is plotted as a function of the number Q of accumulation periods and then follows a law (or curve or function) very similar to that of the model provided by Hajimiri. More exactly, the Allan variance plotted as a function of factor Q comprises a linear portion corresponding to thermal noise, a quadratic portion corresponding to flicker noise, and a noise floor corresponding to the quantization noise inherent to any acquisition. By performing a quadratic regression of the plotted curve to approximate it by a function of the type σ(Q)\hat{ }2=a0+a1.Q+a2.Q\hat{ }2, with σ(Q) the Allan variance as a function of the Q accumulation, it is possible to obtain coefficients a0, a1, and a2, which represent the coefficients respectively for quantization noise, thermal noise, and flicker noise. Obtaining coefficients a0, a1, and a2 thus amounts to characterizing the entropy source, that is, the jitter of the first oscillator.

However, this first method has the disadvantage that the contribution of the frequency divider circuit to the final noise is not known.

Further, in this first method, the characterization of the jitter of the first oscillator is implemented by a circuit arranged next to the processing of the entropy source, which requires significant additional surface area, in particular to implement quadratic regression.

A second method is disclosed in the article “Embedded Evaluation of Randomness in Oscillator Based Elementary TRNG”, by V. Fischer and D. Lubicz, presented in “Advanced Information Systems Engineering”, vol. 7908, Springer Berlin Heidelberg, 2014, pp. 527-543. This method consists in sampling the output signal of the first oscillator with a synchronous D flip-flop clocked at the frequency of the second oscillator. The output signal of the flip-flop then is a periodic signal having a mean period Tm inversely proportional to the difference between the periods of the two oscillators. More specifically, the length of period Tm in number Nm of periods of the oscillator signal is such that Nm=T1/(T1−T2), with T1 and T2 the mean value of the periods of the first and second oscillators, respectively. Next, a variance is calculated on the resultant of an XOR operation between two values of the output signal of the flip-flop separated from each other by G periods of the second oscillator. The variance as a function of G then has two portions, one varying linearly with G, which corresponds to thermal noise, and a portion varying quadratically with G, which corresponds to flicker noise. In the same way as hereabove, it is possible to characterize the entropy source, and thus the jitter of the first oscillator, by performing a quadratic regression of the variance plotted as a function of G.

However, this second method has the disadvantage of being based on frequency ratios Nm/G which are not controlled but suffered, and accordingly the accuracy of this second method is low and uncontrollable between different circuits.

Further, in this second method, as in the first method, the characterization of the jitter of the first oscillator is implemented by a circuit arranged next to the processing of the entropy source, which requires significant additional surface area.

There has been provided in patent application FR 3134795 and in patent application US 202401954 a device for overcoming the disadvantages of the two above-described methods. The device provided in these applications is similar to the device used in the second method. In other words, the provided device is of coherent sampling oscillator based true random number generator (COSO-TRNG) type. In these applications, the oscillators are implemented in SOI (Semiconductor On Insulator) technology. In the device, a counter receives an output signal of a flip-flop sampling the first oscillator at the frequency of the second oscillator. Further, the counter is configured to count a number N of periods of the second oscillator during each period of the output signal of the flip-flop. In the device, there is further provided a circuit enabling to set the period of at least one of the two oscillators, so as to set the mean difference between the mean period of each of the two oscillators. In other words, it is possible to set the period of the output signal of the flip-flop, and thus the mean output value Nm of the counter. A circuit characterizes the entropy of the entropy source based on the output values N of the counter, by calculating an Allan variance on these N output values. Once the entropy has been characterized, a value K of accumulation of the output values N of the counter is selected based on a target minimum entropy, so that a least significant bit of a value corresponding to the accumulation of K output values N of the counter can be used as a random bit for random number generation. In the device provided in these applications, one or more alarm circuits enabling to detect a malfunction of the entropy source are also provided.

Although this device solves at least some of the problems of the first and second above-described methods, at least three different values of accumulation of the output values N of the counter are used to characterize the entropy. Further, once the entropy has been characterized, still another value of accumulation of the output values N of the counter is selected and used to generate a random bit. This makes the device complex.

### SUMMARY

There exists a need to overcome all or part of the disadvantages of known devices comprising an entropy source based on the jitter of a ring oscillator.

An embodiment overcomes all or part of the disadvantages of known devices comprising an entropy source based on the jitter of a ring oscillator.

An embodiment provides an electronic device comprising:
a first ring oscillator and a second ring oscillator;
a synchronous flip-flop configured to deliver an output signal corresponding to a sampling of an output of the first oscillator at a frequency of an output of the second oscillator;
a counter configured to deliver, for each period of the output signal of the flip-flop, a value equal to a number of periods of the second oscillator counted during said period of the output signal of the flip-flop;
a first circuit configured to modify a period of at least one of the two oscillators so that a mean difference between the periods of the two oscillators is equal to a target difference; and
a second circuit configured to:
   initialize a value of an integer K,
   calculate sums of K successive values of the counter,
   calculate an Allan variance on the calculated sums, and
   set K to its current value if the calculated variance is greater than a first threshold, and increment K otherwise,
   wherein the first threshold is equal to the highest of a second threshold determined by a target entropy on a least significant bit of the calculated sums and of a third threshold determined by an autocorrelation threshold on said bit.

According to an embodiment, the first and second ring oscillators are identical, for example, by design.

According to an embodiment, the first circuit is configured to modify said period of said at least one of the two oscillators based on the values of the counter.

According to an embodiment, the third threshold is equal to 0.25.

According to an embodiment, the second circuit comprises an accumulator circuit configured to receive the values of the counter, an indication of the current value of number K, and to deliver said sums in the form of a digital word.

According to an embodiment, the device further comprises a third circuit configured to deliver a first alarm signal if the calculated variance is outside a range of values determined by the first threshold, the range of values comprising, for example, all values greater than or equal to a first value determined by the first threshold, the first value being, for example, equal to 0.9 time the first threshold.

According to an embodiment, the device further comprises a fourth circuit configured to deliver a second alarm signal if a value of the counter is greater than a threshold determined by the target difference.

According to an embodiment, the first and second ring oscillators are implemented in semiconductor-on-insulator technology, preferably in fully depleted semiconductor-on-insulator technology, and the first circuit is configured to control back gates of at least one delay element of said at least one of the two oscillators to modify the mean difference between the periods of the two oscillators.

According to an embodiment, the first circuit is configured to modify said period of said at least one of the two oscillators during a first phase of a setting step.

According to an embodiment, the second circuit is configured to set the value of number K during a second phase of the setting step, implemented after the first phase.

An embodiment provides a random number generator comprising the device such as described, wherein the random numbers are generated from the least significant bit of the calculated sums.

An embodiment provides a method implemented in an electronic device comprising a first ring oscillator and a second ring oscillator, a synchronous flip-flop configured to deliver an output signal corresponding to a sampling of an output of the first oscillator at a frequency of an output of the second oscillator, and a counter configured to deliver, for each period of the output signal of the flip-flop, a value equal to a number of periods of the second oscillator counted during said period of the output signal of the flip-flop, the method comprising:

modifying with a first circuit a period of at least one of the two oscillators so that a mean difference between the periods of the two oscillators is equal to a target difference;
initializing with a second circuit a value of an integer K;
calculating with the second circuit sums of K successive counter values; calculating with the second circuit an Allan variance on the calculated sums; and
with the second circuit, setting K to its current value if the calculated variance is greater than a first threshold and incrementing K otherwise,
wherein the first threshold is equal to the highest of a second threshold determined by a target entropy on a least significant bit of the calculated sums and of a third threshold determined by an autocorrelation threshold on said bit.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows, in the form of a block diagram, an embodiment of an electronic device;

FIG. 2 shows, in the form of a flowchart, an embodiment of a method implemented in the device of FIG. 1;

FIG. 3 shows, in the form of a block diagram, an alternative embodiment of the device of FIG. 1.

### DETAILED DESCRIPTION OF THE PRESENT EMBODIMENTS

Like features have been designated by like references in the various figures. In particular, the structural and/or functional features that are common among the various embodiments may have the same references and may dispose identical structural, dimensional and material properties.

For the sake of clarity, only those steps and elements that are useful for understanding the described embodiments have been shown and are described in detail. In particular, the usual methods and circuits using an entropy source for the generation of true random numbers have not been detailed, the embodiments and variants described herein being compatible with these usual methods and circuits.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as the terms “front”, “back”, “top”, “bottom”, “left”, “right”, etc., or relative position qualifiers, such as the terms “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10% or 10°, preferably of plus or minus 5% or 5°.

A device comprising identical first and second ring oscillators and a flip-flop sampling the first oscillator at the frequency of the second oscillator is here considered. In such a device, called reference device, the output values of the flip-flop are accumulated and a least significant bit of the accumulated value is intended to be used as a random bit, for example in a true random number generator. As described hereabove, the accumulation value needs to be carefully selected to respect a minimum target entropy on this bit, and, further, as conventional, to be in the range of accumulation values where the jitter is dominated by the thermal component and not by the flicker noise component.

However, in the reference device, it has been shown by L. Benea, M. Carmona, V. Fischer, F. Pebay-Peyroula, and R. Wacquez, in the article “Impact of the Flicker Noise on the Ring Oscillator-based TRNGs”, published in IACR Transactions on Cryptographic Hardware and Embedded Systems, vol. 2024, no. 2, Art. no. 2, March 2024, for example in relation with FIGS. 12, 13, 14, and 16 of this article, as for example summarized at page 885 of the article, that the autocorrelation of the random bit related to flicker noise can be considered as zero or negligible beyond a minimum accumulation value. This minimum accumulation value corresponds, for example, to the time when the Allan variance of the jitter calculated on the accumulated values becomes equal to the square of half the mean period of the oscillators, and preferably equal to the square of half the mean period of the sampling oscillator.

It is here provided to take advantage of what has been shown in the above-mentioned article, in order to simplify the device and the entropy characterization method. In particular, it is here provided to take advantage of the fact that in the reference device introduced hereabove, the autocorrelation is zero beyond an accumulation value.

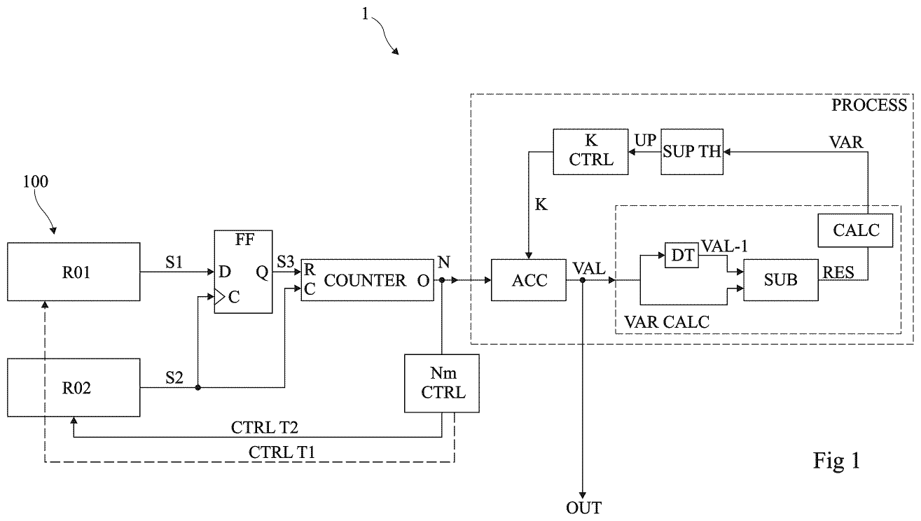

FIG. 1 illustrates, schematically and in the form of blocks, an example of an embodiment of a device 1.

Circuit 1 comprises two identical ring oscillators RO1 and RO2. Oscillator RO1, respectively RO2, delivers a periodic output signal S1, respectively S2.

Circuit 1 further comprises a synchronous flip-flop (FF), for example a D-type flip-flop. Flip-flop FF is configured to sample signal SI at the frequency of signal S2.

In other words, flip-flop FF configured to update an output signal S3 at each beginning of a period of signal S2 with the binary value of signal S1, each beginning of a period of signal S2 corresponding to an active edge of signal S2, for example a rising edge. Between two successive updates of signal S3, signal S3 is held at its current value, that is, the value taken by signal S3 during the first of the two successive updates.

For example, flip-flop FF comprises a data input D configured to receive signal S1, an input C for clocking (timing) the updates of signal S3 configured to receive signal S2, and a Q output configured to deliver signal S3.

The two oscillators RO1 and RO2 and flip-flop FF form an entropy source 100. The randomness extracted from entropy source 100 is generated from the value of period T of signal S3. Signal S3 is a periodic signal having a mean period Tm with a mean duration Nm in number of periods of signal S2 inversely proportional to the difference between periods T1 and T2, according to formula Nm=T1/(T1−T2). Signal S3 has an instantaneous period T that varies with the jitter of signal S1. Thus, the measurement of period T, that is, of the duration of period T, is representative of the jitter of signal S1.

Entropy source 100 is a structure designated, for example, with the acronym COSO (COherent Sampling Ring Oscillator), which is used in coherent sampling ring oscillator true random number generator (COSO TRNG) circuits.

To measure the period T of signal S3, circuit 1 comprises a circuit (or counter) COUNTER. Circuit COUNTER is configured to deliver, for each period T of signal S3, a value N, for example in the form of a digital word, equal to the number of periods T2 of signal S2 counted during period T of signal S3. In other words, circuit COUNTER is configured to measure the duration of each period T of signal S3 in number N of periods T2 of signal S2.

As an example, circuit COUNTER comprises a reset input receiving signal S3, a clock input C receiving signal S2, and an output O delivering the counted values N. At the beginning of each period T2 of signal S2, for example at each rising edge of signal S2, circuit COUNTER increments the current count value by one unit. At each beginning of a period T of signal S3, for example at each rising edge of signal S3, circuit COUNTER resets the current count value to zero. Preferably, the value N available at the output of circuit COUNTER, on output O, is updated based on the current count value at each beginning of a period of signal S3, just before this current count value is reset to zero. In other words, the value N available at the output of circuit COUNTER is updated at the beginning of each period T of signal S3 with the value of the number of periods T2 of signal S2 counted during the previous period T.

Device 1 further comprises a circuit Nm CTRL. Circuit FB CTRL is configured to control or modify the period of at least one of the two oscillators ROI and RO2 so that the difference between periods T1 and T2 is equal to a target difference. The modification of period T1 of oscillator RO1 and/or of period T2 of oscillator RO2 by circuit Nm CTRL is implemented based on the output values N of circuit COUNTER. For example, for a target value Nmt of the average number Nm of periods T2 per period T of signal S3, if output value N is smaller than Nmt, the difference between periods T1 and T2 is decreased, and if output value N is greater than Nmt, the difference between periods T1 and T2 is increased.

According to an embodiment, both oscillators RO1 and RO2 are implemented in complementary metal oxide semiconductor (CMOS) on fully depleted semiconductor on insulator (FDSOI), preferably on fully depleted silicon on insulator (FDSOI), technology. In such an embodiment, preferably, the modification of period T1 of oscillator RO1, respectively of period T2 of oscillator RO2, is implemented by controlling the back gates of at least one delay element, for example an inverter, of oscillator RO1, respectively RO2.

In alternative embodiments, whether or not oscillators RO1 and RO2 are implemented in CMOS on FDSOI, the modification of period T1 of oscillator RO1, respectively of period T2 of oscillator RO2, is implemented differently, for example by selecting an oscillation propagation path from among a plurality of possible paths, or by modifying the oscillator power supply conditions. As an example, the article by A. Peetermans, V. Rozic, and I. Verbauwheden entitled “A Highly-Portable True Random Number Generator Based on Coherent Sampling”, published in 2019 in 29th International Conference on Field Programmable Logic and Applications (FPL), describes an example of setting of the relative periods of two ring oscillators which is not based on the use of a back gate of at least one delay element, for example an inverter, of oscillator RO1, respectively RO2.

However, the use of back gates to modulate the period of at least one of oscillators RO1 and RO2 when they are implemented in CMOS on FDSOI allows for greater setting dynamics and an improved accuracy of the setting of the difference between periods T1 and T2.

In the example of FIG. 1, circuit Nm CTRL only controls the period T2 of oscillator RO2 by means of a control signal CTRL T2. In an alternative embodiment, as illustrated by dotted lines in FIG. 1, circuit Nm CTRL further controls period T1 of oscillator RO1 by means of a control signal CTRL T1. In another variant, not shown, circuit Nm CTRL only controls period T1 of oscillator RO1 by means of signal CTRL T2.

In device 1, in each of oscillators RO1 and RO2, the ratio R of the oscillator period to its jitter can be determined and depends on the technology used to implement the oscillators. For example, when the oscillators are implemented in CMOS on FDSOI, this ratio R is in the order of 1000. In practice, for a given technology, this ratio can be obtained by a phase of characterization, for example, of a plurality of circuits.

Further, in device 1, the measurement accuracy is determined by the difference between periods T1 and T2. More specifically, the measurement accuracy is equal to 1/Nm.

A sufficient measurement accuracy is, for example, achieved when Nm is substantially equal to R. However, in other examples, a measurement accuracy where Nm is smaller than R may be sufficient, for example a measurement accuracy where Nm is equal to R/10 may be sufficient. Those skilled in the art are capable of determining a target measurement accuracy depending on the application. For example, for two oscillators RO1 and RO2 having periods T1 and T2 equal to 2 ps, to have a measurement accuracy of 1/1,000, the difference between periods T1 and T2 needs to be set by circuit Nm CTRL to 2 ns, that is, circuit Nm CTRL for example needs to set the period of oscillator RO1 to 2.002 ns and that of oscillator RO2 to 2.000 ns.

It can thus be understood that the accuracy of control of the periods T1 and/or T2 of the oscillators by circuit Nm CTRL is determined by the target measurement accuracy. Taking above-described case example, for oscillators RO1 and RO2 implemented in CMOS on FDSOI, the control signals CTRL T1 and CTRL T2 of the back gates need to be able to be modified with an accuracy in the order of one mV to obtain the target difference equal to 2 ns in this example.

In practice, the setting of the difference between the mean periods of signals S1 and S2 enables the output values N of circuit COUNTER to vary around value Nm according to the jitter of oscillator RO1, which is accumulated over Q equals Nm periods of signal T2.

The setting of the mean output value Nm of counter COUNTER by circuit Nm CTRL corresponds, for example, to a first step of a setting phase.

Device 1 further comprises a circuit PROCESS. Circuit PROCESS is configured, once the mean period Tm has been set by circuit Nm CTRL, to determine a value K of accumulation of the output values N of counter COUNTER, so that the Q jitter accumulation (equal to K*Nm) is sufficient, on the one hand, for the entropy of a random bit generated from the accumulation of K successive values N to be greater than a minimum entropy, and, on the other hand, for the autocorrelation linked to flicker noise to be zero or, at least, considered negligible. This determination of the value of integer K corresponds, for example, to a second phase of the setting step, which is implemented after the first phase of the setting step.

More particularly, circuit PROCESS is configured to first initialize the current value of number K, that is, so that the current value of number K is set to an initial value. As an example, the initial value of number K is in the range from 1 to 1,000, for example equal to 10.

Circuit PROCESS is also configured to accumulate K successive N values. In other words, circuit PROCESS is configured to calculate sums of K successive values N of counter COUNTER. For example, each time circuit COUNTER delivers a value N representative of a number of periods of signal S2 counted during a period of signal S3, circuit PROCESS adds this value N to previous values N, until it has added K successive values N.

For example, in FIG. 1, in circuit PROCESS, the function of accumulating K successive values N is represented in the form of a functional block ACC receiving values N and an indication of the current value of number K, for example receiving number K, and delivering values VAL corresponding to sums (accumulations) VAL of K successive values N. In other words, block ACC is configured to calculate sums VAL of K successive values N. For example, each update of value VAL corresponds to the result of an accumulation of K successive values N. As an example, each value VAL corresponds to the accumulation of the jitter of oscillator RO1 (signal S1) over Q=Nm*K periods of signal S2.

As an example, the output values N of the counter are provided by circuit COUNTER in the form of digital words over a plurality of bits. Preferably, the calculated sums VAL are delivered by block ACC in the form of multi-bit digital words over a plurality of bits.

As an example, functional block ACC is implemented by an accumulator circuit receiving values N and the indication of the current value of K, and delivering sums VAL.

Circuit PROCESS is further configured to calculate, based on sums VAL, an Allan variance. In other words, circuit PROCESS is configured to calculate an Allan variance on sums VAL. This function of circuit PROCESS is represented in FIG. 1 by a functional block VAR CALC receiving values VAL and delivering an Allan variance value VAR. As an example, this block VAR CALC is implemented by a corresponding circuit, for example by a corresponding digital circuit.

As an example, to calculate the Allan variance VAR on values VAL, block VAR CALC is configured to subtract a current VAL value from a value VAL-1 corresponding to the value VAL obtained before the current value VAL. This subtraction function is shown in FIG. 1 in the form of a functional block SUB receiving the two successive values VAL and VAL-1, and delivering the result RES of the subtraction between these two successive values. As an example, block SUB is implemented by a corresponding circuit, for example a digital subtractor circuit.

As an example, values VAL-1 are obtained by delaying values VAL, as illustrated in FIG. 1 by a functional block DT receiving values VAL and delivering values VAL-1. As an example, block DT is implemented by a corresponding circuit, for example, a shift register, for example a FIFO (First In First Out) shift register of depth 1, in which shifts are implemented at each update of signal VAL.

As an example, circuit VAR CAL calculates the Allan variance VAR based on the differences RES between values VAL-1 and VAL as illustrated in FIG. 1 by a functional block CALC receiving differences RES and delivering the calculated Allan variance VAR. As an example, block CALC is implemented by a corresponding circuit, for example by a corresponding digital circuit.

Circuit PROCESS is configured to compare the Allan variance VAR calculated on the accumulations VAL of K successive output values N of circuit COUNTER with a threshold TH, as illustrated in FIG. 1 by a functional block SUP TH receiving the calculated variance VAR and providing an indication UP of the result of the comparison of the calculated variance with a threshold TH. As an example, block SUP TH is implemented by a corresponding, preferably digital, circuit receiving signal VAR and delivering signal UP, for example in the form of a binary signal having its state indicating whether variance VAR is greater or smaller than threshold TH.

More particularly, threshold TH is equal to the highest threshold among a threshold TH1 and TH2.

Threshold TH1 is determined by the target entropy of a random bit OUT output by circuit PROCESS. This bit OUT corresponds to the least significant bit of the sums VAL of K successive values N. For example, for a target entropy of given value, the Allan variance corresponding to this target entropy is calculated, and threshold TH1 is then equal to this calculated Allan variance. For example, the article by M. Baudet, D. Lubicz, J. Micolod, and A. Tassiaux, entitled “On the Security of Oscillator-Based Random Number Generators”, and published in J Cryptol, vol. 24, no. 2, pp. 398-425, April 2011, gives a reference model adapted to the values N of circuit COUNTER, which indicates that variance VAR must be greater than threshold TH1 for the entropy of bit OUT to be greater than the target entropy. In other words, this model enables to calculate, for the target entropy, the value of variance threshold TH1 such that the entropy of bit OUT is greater than the target entropy when the calculated variance VAR is greater than threshold TH1. As an example, for a target entropy equal to 0.0997, threshold TH1 is equal to 0.538. As an example, having an entropy of bit OUT greater than 0.997 is a required condition to comply with the AIS-31 standard.

Threshold TH2 is determined by an autocorrelation threshold on bit OUT. Indeed, as previously indicated, the article “Impact of the Flicker Noise on the Ring Oscillator-based TRNGs” shows that the autocorrelation linked to flicker noise can be related to the Allan variance, and that this autocorrelation is zero or negligible when the calculated variance VAR is greater than a threshold. As an example, for a threshold TH2 equal to 0.25, the autocorrelation linked to flicker noise is zero. For example, threshold TH2 is equal to the Allan variance of the accumulated values when this Allan variance is greater than or equal to the square of half the mean period of the oscillators.

Taking threshold TH equal to the highest of thresholds TH1 and TH2, if the calculated variance VAR is greater than threshold TH, this means that the Q accumulation is equal to Nm.K, and thus, that the current value of K, is sufficient for the autocorrelation of bit OUT due to flicker noise to be zero or negligible, and for the entropy of bit OUT to be greater than the target entropy.

Thus, when the calculated Allan variance VAR is greater than threshold TH, there is no need to modify the value of number K, and the value of number K is set to be equal to its current value. This marks, for example, the end of the second phase of the setting step, or, more generally, the end of the setting step. After this setting step, the bits OUT which are provided by circuit PROCESS may be used for true random number generation, for example by a true random number generation circuit comprising device 1 and using bits OUT to generate true random numbers.

Conversely, when the calculated Allan variance VAR is smaller than threshold TH, this means that at least one of the conditions on the entropy of bit OUT and on the autocorrelation due to flicker noise is not met, and that the Q jitter accumulation value needs to be increased. This increase in the Q accumulation value is implemented by incrementing by a given step, for example a unit step, the current value of accumulation K.

Circuit PROCESS is thus configured to set K to its current value if the calculated variance VAR is greater than threshold TH, and to increment K if the calculated variance VAR is smaller than threshold TH. This function of circuit PROCESS is shown in FIG. 1 in the form of a functional block K CTRL configured to receive the indication UP that the calculated variance VAR is greater or smaller than the threshold TH, and to increment the current value of the accumulation if variance VAR is smaller than threshold TH, and to set accumulation K to its current value if variance VAR is greater than threshold TH. As an example, functional block K CTRL provides the indication of the current accumulation K value to block ACC. As an example, functional block K CTRL is implemented in the form of a digital circuit, for example in the form of a counter comprising the current value of K and incrementing this value when this is necessary.

The circuit PROCESS of the device 1 of FIG. 1 is simpler to implement than the circuit PROCESS of the device of applications FR 3134795 and US 202401954. In particular, it is not necessary in the device 1 disclosed herein to first characterize the entropy and then to determine a value K of accumulation of the values N for which an output bit respects a minimum target entropy. Further, in the device 1 disclosed herein, flicker noise can be a legitimate source of randomness, whereby the throughput of the random bits OUT delivered by device 1 can be increased with respect to that of the random bits which are delivered by the device of the above-mentioned patent applications.

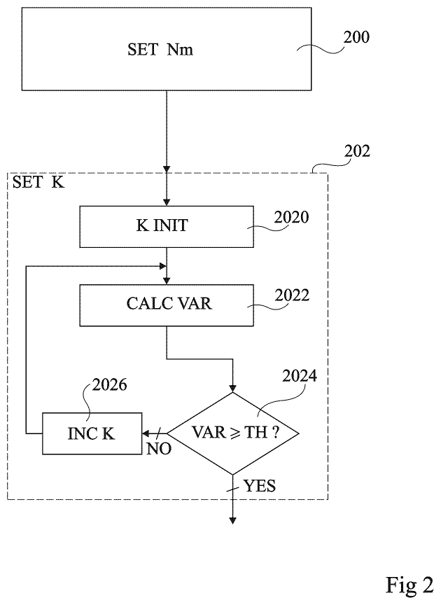

FIG. 2 shows, in the form of a flowchart, an embodiment of a method implemented in the device 1 of FIG. 1. More particularly, FIG. 2 illustrates a step of setting of device 1 prior to the obtaining of random bits OUT complying with the conditions of minimum target entropy and of zero or negligible autocorrelation.

In a first phase or step 200 (block “SET Nm” in FIG. 2) of the setting step, circuit Nm CTRL controls the period of at least one of the two oscillators RO1 and RO2 so that the difference between the mean periods of the two oscillators is equal to a target difference. In other words, circuit Nm CTRL controls the period of at least one of the two oscillators RO1 and RO2 so that the mean period value Nm of signal S2 during a period of signal S3 is equal to a target value.

In a second phase or step 202 (block “SET K” in FIG. 2) of the setting step, implemented after step 200, circuit PROCESS sets the value of accumulation K so that the two above-mentioned conditions are met.

More particularly, at step 202, the current value of K is initialized at a step 2020 (“K INIT” block in FIG. 2). The initialization of the current value of K is for example implemented by circuit PROCESS.

Then, still at step 202, at a step 2022 (“CALC VAR” block in FIG. 2), circuit PROCESS calculates sums (VAL in FIG. 1) of K successive values N of counter COUNTER, and calculates an Allan variance (VAR in FIG. 1) on these sums.

Steps 2020 and 2021 correspond to the steps implemented by the functional block or circuit VAR CALC of FIG. 1.

Still at step 202, circuit PROCESS compares the calculated Allan variance with threshold TH, at a step 2024 (block “VAR≥TH” in FIG. 2). This step corresponds to the step implemented by the functional block or circuit SUP TH in FIG. 1.

If the calculated variance is greater than threshold TH (“YES” output of block 2024), step 202, and more generally the step of setting of device 1, is completed. The value of K is then set, and random bits OUT corresponding to the least significant bit of the sums of K successive values N are then delivered by circuit PROCESS. It should thus be understood that, once the current value of accumulation K has been set during the setting step, circuit PROCESS keeps on calculating sums of K successive values N.

Conversely, if the calculated variance is smaller than threshold TH (output “NO” of block 2024), step 2024 continues at a step 2026 (block “INC K” in FIG. 2) in which the current value of K is incremented. This step corresponds to the step implemented by the functional block or circuit K CTRL of FIG. 1.

Step 2026 is followed by step 2022.

In the above-described device 1, in addition to implementing a simple setting step enabling to obtain random bits OUT complying with the two conditions relative to entropy and autocorrelation, it may be desirable to detect malfunctions of entropy source 100. Indeed, once the value of K has been set, entropy source 100 may exhibit various problems that lead to the bits OUT supplied by circuit PROCESS no longer meeting the two conditions relative to entropy and autocorrelation.

For example, signal S3 may lock, that is, it may no longer vary periodically over time, with a mean period corresponding to a number Nm of periods of signal S2. This locking of signal S3 may be the result of oscillators RO1 and RO2 locking onto each other. This locking of signal S3 may also be the result of an attack on device 1 by a pirate.

As another example, due to temperature variation or to an aging of device 1, the Allan variance on the sums of K successive output values N of circuit COUNTER may once again fall below threshold TH after the value of K has been set during the setting step.

It would thus be desirable, in the device 1 of FIG. 1, to have means enabling to detect at least one of a locking of signal S3 and of a variation of the Allan variance below threshold TH.

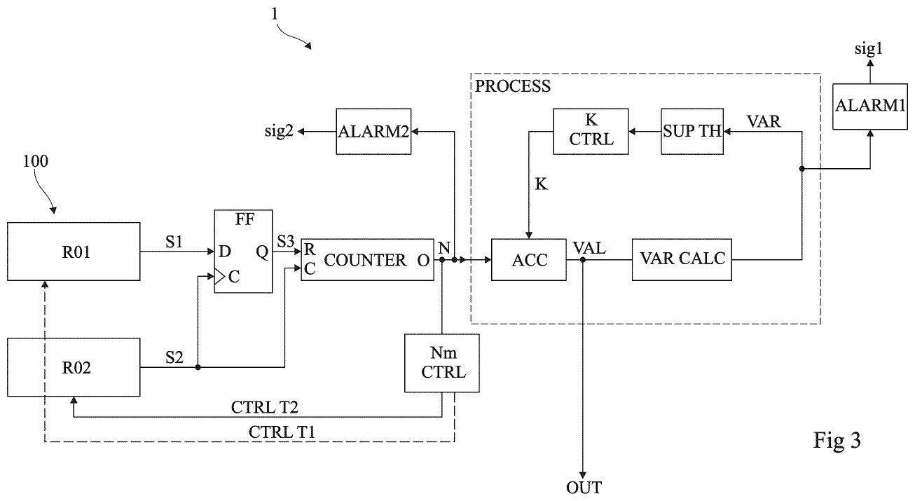

FIG. 3 shows, in the form of a block diagram, an alternative embodiment of the device of FIG. 1. The device 1 of FIG. 3 has many features in common with the device 1 of FIG. 1, and only the differences between these two devices are here highlighted. In particular, unless otherwise indicated, all that has been described for the device 1 of FIG. 1 remains valid for the device 1 of FIG. 3.

The device 1 of FIG. 3 comprises a circuit ALARM1. Circuit ALARM1 is configured to detect when the Allan variance VAR calculated on the sums VAL of K successive values N falls outside a range determined by threshold TH. Circuit ALARM1 provides an alarm signal sig1 indicating when the Allan variance VAR falls outside this range. The step of detection that variance VAR has fallen outside the range is preferably carried out after the setting step having enabled to set the value of K.

As an example, the range of values determined by threshold TH extends from a first value, preferably included in the range of values, to a second value, preferably included in the range of values. The first value is lower than threshold TH, for example equal to 0.7 time threshold TH, preferably equal to 0.9 time threshold TH, and the second value is higher than threshold TH, for example equal to 1.3 time threshold TH, preferably equal to 1.1 time threshold TH.

As an alternative example, the range of values comprises all values greater than or equal to a first value determined by threshold TH. The first value is smaller than the threshold TH, for example equal to 0.7 time threshold TH, preferably to 0.9 time threshold TH.

Rather than detecting, with circuit ALARM1, that the calculated variance VAR is outside the range of values defined hereabove, it could have been thought of simply detecting that the calculated variance VAR is lower than threshold TH. However, in operation, variance VAR may occasionally be smaller than threshold TH, without this being the result of a malfunction in the entropy source. Indeed, in operation, even in the absence of a malfunction of the entropy source, the calculated variance VAR may take values close to threshold TH, which will sometimes be lower than threshold TH, sometimes higher than threshold TH. This is why the use of a range of values is preferable.

As an example, when circuit ALARM1 delivers signal sig1 to indicate that the calculated variance VAR has fallen outside the range of values determined by threshold TH, the setting step described in relation with FIGS. 1 and 2 may be carried out again, so as to set a new value of K for which the bits OUT will comply with the two conditions relative to entropy and autocorrelation.

It should be understood from the above-described operation of circuit ALARM1 that, when device 1 comprises circuit ALARM1, circuit PROCESS is configured to calculate the Allan variance of the sums VAL of K successive values N after the value of K has been set.

The device 1 of FIG. 3 further comprises a circuit ALARM2. Circuit ALARM2 is configured to detect a locking of signal S3. For this purpose, circuit ALARM2 is configured to provide an alarm signal sig2 if a value N of counter COUNTER is greater than a threshold determined by the mean value Nm set, by circuit Nm CTRL, during the setting step. In other words, circuit ALARM2 is configured to deliver an alarm signal sig2 if a COUNTER value N is greater than a threshold determined by the target difference between the mean periods of signals S1 and S2. Preferably, the comparison of values N with the threshold by circuit ALARM2 is implemented after the end of the setting step described in relation with FIGS. 1 and 2, that is, after circuit Nm CTRL has set the mean value of the periods of oscillators RO1 and RO2.

The threshold with which circuit ALARM2 compares the output values N of counter COUNTER is higher than the set value Nm. If a value N exceeds this threshold, this means that signal S3 is in a locked situation, and circuit ALARM2 indicates this by means of signal sig2. As an example, this threshold is equal to 1.5 time Nm, for example 2 times Nm.

As an example, when circuit ALARM2 detects a locking of signal S3 and indicates it by means of signal sig2, circuit 1 is configured to reset oscillators RO1 and RO2, for example by blocking with a control signal the propagation of oscillations in these oscillators before allowing this propagation again. After such a step of resetting of oscillators RO1 and RO2, the setting step described in relation with FIGS. 1 and 2 is carried out again.

Although a device 1 comprising both circuits ALARM1 and ALARM2 has been described hereabove, in variants, not shown, device 1 comprises only one of these two circuits ALARM1 and ALARM2. Even in these variants where the device comprises only one of the two circuits ALARM1 and ALARM2, device 1 has advantages over the device 1 of FIG. 1 lacking circuits ALARM1 and ALARM2.

As an example, although this not illustrated in FIG. 3, device 1 may comprise an alarm circuit configured to detect a change in the operation of device 1, for example resulting from an aging of device 1. This alarm circuit is configured to calculate, at the end of the setting phase of device 1, once value K has been set, a mean value VARmeans of the Allan variance over a plurality of Allan variance values VAR. This alarm circuit is further configured, once mean value VARmeans has been calculated, to detect when an Allan variance value VAR falls outside a range of values determined by mean value VARmeans. This range of values extends from a first value, preferably included in the range of values, to a second value, preferably included in the range of values. The first value is smaller than value VARmeans, for example 0.7 time value VARmeans, preferably 0.9 time value VARmeans, and the second value is greater than threshold TH, for example 1.3 time value VARmeans, preferably 1.1 time value VARmeans.

By indicating when the Allan variance comes out of the range of values determined by value VARmeans, this alarm indicates when the operation of device 1 deviates from the operation set at the end of the setting phase. However, this alarm may be triggered while the Allan variance is still above threshold TH, that is, while the autocorrelation of bit OUT due to flicker noise is zero or negligible and the entropy of bit OUT is greater than the target entropy.

For example, if a threshold equal to 0.538 is considered and, after having set value K, a mean value VARmeans equal to 0.7 is obtained, the range of values determined by value VARmeans extends, for example, from 0.9 time VARmeans to 1.1 time VARmeans. In this example, an Allan variance equal to 0.6 is smaller than 0.9 time VARmeans and triggers the alarm, while this same Allan variance is higher than threshold TH, which indicates that the autocorrelation of bit OUT due to flicker noise is zero or negligible and that the entropy of bit OUT is greater than the target entropy. In other words, in this example, despite a drift in the operation of device 1, for example resulting from an aging of device 1, device 1 remains functional to deliver random bits OUT with an entropy greater than the target entropy.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove.

1. Electronic device comprising:
a first ring oscillator and a second ring oscillator;
a synchronous flip-flop configured to deliver an output signal corresponding to a sampling of an output of the first oscillator at a frequency of an output of the second oscillator;
a counter configured to deliver, for each period of the output signal of the flip-flop, a value equal to a number of periods of the second oscillator counted during said period of the output signal of the flip-flop;
a first circuit configured to modify a period of at least one of the two oscillators so that a mean difference between the periods of the two oscillators is equal to a target difference; and
a second circuit configured to:
initialize a value of an integer K,
calculate sums of K successive values of the counter,
calculate an Allan variance on the calculated sums, and
set K to its current value if the calculated variance is greater than a first threshold, and increment K otherwise,
wherein the first threshold is equal to the highest of a second threshold determined by a target entropy on a least significant bit of the calculated sums and of a third threshold determined by an autocorrelation threshold on said bit.

2. Device according to claim 1, wherein the first and second ring oscillators are identical, for example, by design.

3. Device according to claim 1, wherein the first circuit is configured to modify said period of said at least one of the two oscillators based on the values of the counter.

4. Device according to claim 1, wherein the third threshold is equal to 0.25.

5. Device according to claim 1, wherein the second circuit comprises an accumulator circuit configured to receive the values of the counter, an indication of the current value of number K, and to output said sums in the form of a digital word.

6. Device according to claim 1, wherein the device further comprises a third circuit configured to deliver a first alarm signal if the calculated variance is outside a range of values determined by the first threshold, the range of values comprising, for example, all values greater than or equal to a first value determined by the first threshold, the first value being, for example, equal to 0.9 time the first threshold.

7. Device according to claim 1, wherein the device further comprises a fourth circuit configured to deliver a second alarm signal if a value of the counter is greater than a threshold determined by the target difference.

8. Device according to claim 1, wherein the first and second ring oscillators are implemented in semiconductor-on-insulator technology, preferably in fully depleted semiconductor-on-insulator technology, and the first circuit is configured to control back gates of at least one delay element of said at least one of the two oscillators to modify the mean difference between the periods of the two oscillators.

9. Device according to claim 1, wherein the first circuit is configured to modify said period of at least one of the two oscillators during a first phase of a setting step.

10. Device according to claim 9, wherein the second circuit is configured to set the value of number K during a second phase of the setting step, implemented after the first phase.

11. Random number generator comprising the device according to claim 1, wherein the random numbers are generated from the least significant bit of the calculated sums.

12. Method implemented in an electronic device comprising a first ring oscillator and a second ring oscillator, a synchronous flip-flop configured to deliver an output signal corresponding to a sampling of an output of the first oscillator at a frequency of an output of the second oscillator, and a counter configured to deliver, for each period of the output signal of the flip-flop, a value equal to a number of periods of the second oscillator counted during said period of the output signal of the flip-flop, the method comprising:
modifying with a first circuit a period of at least one of the two oscillators so that an average difference between the periods of the two oscillators is equal to a target difference;
initializing with a second circuit a value of an integer K;
calculating with the second circuit sums of K successive values of the counter;
calculating with the second circuit an Allan variance on the calculated sums; and
with the second circuit, setting K to its current value if the calculated variance is greater than a first threshold, and incrementing K otherwise,
wherein the first threshold is equal to the highest of a second threshold determined by a target entropy on a least significant bit of the calculated sums and of a third threshold determined by an autocorrelation threshold on said bit.
